(19) United States
(12) Patent Application Publication
(10) Pub. No.: US 2008/0212943 A1
(43) Pub. Date: Sep. 4, 2008

(54) TRIGGERING EVENTS FOR VIDEO RINGTONES

(76) Inventors: Stuart Daniel FROHLICH, Ramat Bet Shemesh (IL); David Elliot Goldfarb, Bet Shemesh (IL); Lawrence Joel Reisler, Bet Shemesh (IL); Gaviel Ra'Anan, Bet Shemesh (IL)

Correspondence Address: DANIEL J SWIRSKY, 55 REUVEN ST., BEIT SHEMESH, 99544, IL

(21) Appl. No.: 12/028,938

(22) Filed: Feb. 11, 2008

Related U.S. Application Data
(60) Provisional application No. 60/889,280, filed on Feb. 11, 2007.

(51) Int. Cl. H04N 7/26

(52) U.S. Cl. 386/124

(57) ABSTRACT

A system includes a unit to receive triggering events from a network operator and a unit to provide media content to a terminal for playing by a media player on the terminal in response to the triggering events. One embodiment is implemented with an IMS (IP multimedia subsystem). In this embodiment, the unit to receive is an application server of an IMS system and the unit to provide has at least one media resource unit of the IMS system and a community server. The community server associates media content with terminals of the IMS system and in response to triggering events and activates the IMS system to provide media content to a relevant terminal in response to a relevant triggering event.

### CROSS-REFERENCE TO RELATED APPLICATIONS

This application claims benefit from U.S. Provisional Patent Application No. 60/889,280, filed Feb. 11, 2007, which is hereby incorporated in its entirety by reference.

### FIELD OF THE INVENTION

The present invention relates to ringtones generally and to server-based ringtones in particular.

### BACKGROUND OF THE INVENTION

A ringtone is a sound played on a phone handset, e.g. on a mobile cellular phone, to announce an incoming phone call. A ringtone is typically selected by the customer of the phone receiving the call. A ringback tone is a sound played on a phone handset when calling another phone. Typically, the tone is chosen by the owner of the dialed phone and is transmitted to the receiving phone from the telephone operator.

A video ringtone or video ringback tone is similar, but uses a video clip rather than an audio sound.

Prior patent applications U.S. Ser. No. 11/544,938 and U.S. Ser. No. 11/772,873, assigned to the common assignees of the present invention and incorporated herein by reference, define a variation of a video ringtone in which the video clip is chosen by the calling party, to be displayed on the called handset. These patent applications also disclose a community server, an Internet-based server that allows customers to choose video clips to be distributed to their friends (or “buddies”).

These patent applications discuss a variety of other opportunities to present a video clip. For example at the end of a call between two handsets, each might see video clip: one chosen by the customer of that phone, or one chosen by the customer of the other phone, or one chosen by the community server.

### SUMMARY OF THE PRESENT INVENTION

There is provided, in accordance with a preferred embodiment of the present invention, a method including providing media content to a terminal for playing by a media player on the terminal in response to triggering events originating at a network operator.

Moreover, in accordance with a preferred embodiment of the present invention, the providing includes activating an IMS (IP Multimedia Subsystem) system to provide the media content.

Further, in accordance with a preferred embodiment of the present invention, the activating includes having an open session between a media content client on a terminal and an IMS application server, using the open session to instruct the media content client to activate the media player and instructing an IMS media resource unit to provide the media content to the terminal.

Moreover, in accordance with a preferred embodiment of the present invention, for call-related triggering events, the activating includes providing media content to at least one of the terminals involved in the call.

Additionally, in accordance with a preferred embodiment of the present invention, a first media content provided to a first terminal is selected by a user of a second terminal. A second media provided to the second terminal may also be selected by a user of the first terminal.

Further, in accordance with a preferred embodiment of the present invention, the triggering events may be generated by at least one non-call-related application.

Still further, in accordance with a preferred embodiment of the present invention, the non-call-related application may be a voicemail module, a location module or a timing module.

There is also provided, in accordance with a preferred embodiment of the present invention, a system including a unit for receiving triggering events from a network operator and a unit for providing media content to a terminal for playing by a media player on the terminal in response to the triggering events.

Moreover, in accordance with a preferred embodiment of the present invention, the unit for receiving is an application server of an IMS system and the unit for providing includes at least one media resource unit of the IMS system and a community server. The community server associates media content with terminals of the IMS system and in response to triggering events and activates the IMS system to provide media content to a relevant terminal in response to a relevant triggering event.

Further, in accordance with a preferred embodiment of the present invention, the system also includes at least one non-call-related application to activate the community server in response to a triggering event.

Still further, in accordance with a preferred embodiment of the present invention, the triggering event may be a call-related triggering event between a first and a second terminal. The community server may have associated at least a first media content selected by a user of a second terminal with the first terminal.

Still further, in accordance with a preferred embodiment of the present invention, the community server has also associated a second media selected by a user of the first terminal with the second terminal.

There is also provided, in accordance with a preferred embodiment of the present invention, a multimedia terminal including a media player, a telephony client to provide telephony via a telephony operator and a media player controller to activate and deactivate the media player in response to externally provided instructions.

Moreover, in accordance with a preferred embodiment of the present invention, the terminal also includes a session controller to open a session with an application server of an IMS system and to receive the instructions from the application server.

Finally, in accordance with a preferred embodiment of the present invention, the terminal also includes a triggering event determiner to instruct the application server when a triggering event on the terminal occurs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of an exemplary system for providing media content in response to triggering events; and

FIG. 2 is a timing diagram illustration of an exemplary call flow within the system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that prior patent applications U.S. Ser. No. 11/544,938 and U.S. Ser. No. 11/772,873 describe a system for mobile handsets that pass information about the call handling to other applications on the handset. Applicants have also realized that IMS (IP Multimedia Subsystem) may enable telecommunications network operators to provide the media content ringing opportunities discussed in U.S. Ser. No. 11/544,938. Since IMS provides telephone and multimedia services to mobile and fixed phones, IMS may have most of the circuitry and protocols to direct both the communication and the multimedia operations of the phones and to coordinate information available on the operator's computer systems.

The present invention may provide media content (audio or video) for many types of triggering events generally originating at the network operator. Some are activated by the network with respect to telephone calls, such as when calling, when receiving a call, at the end of the call, when receiving a busy or a call-waiting signal, etc. Others may utilize the operator's knowledge about the customer. For example, the operator-related triggering events may be related to the status of the customer's voicemail (receipt of a new voicemail, the presence of voicemails in the mailbox, etc), it may be related to the customer's presence (i.e. when the customer joins the network, turns on the phone, etc.) or it may be related to the customer's current location (i.e. when passing locations of interest, utilizing a toll-road or in a particular area). Other operator-related triggering events may be time-based. For example, when the customer is known to be driving to work or when it's time for an afternoon snack.

Such operator-related media content may be chosen by the customer, by the customer's buddies or by advertisers. These media content may be played on the customer's device as part of a telephone call (automated or otherwise) or they may be pushed to the customer's device without any connection to a phone call.

It will be appreciated that the triggering events described hereinabove may be implemented with IMS and/or other protocols.

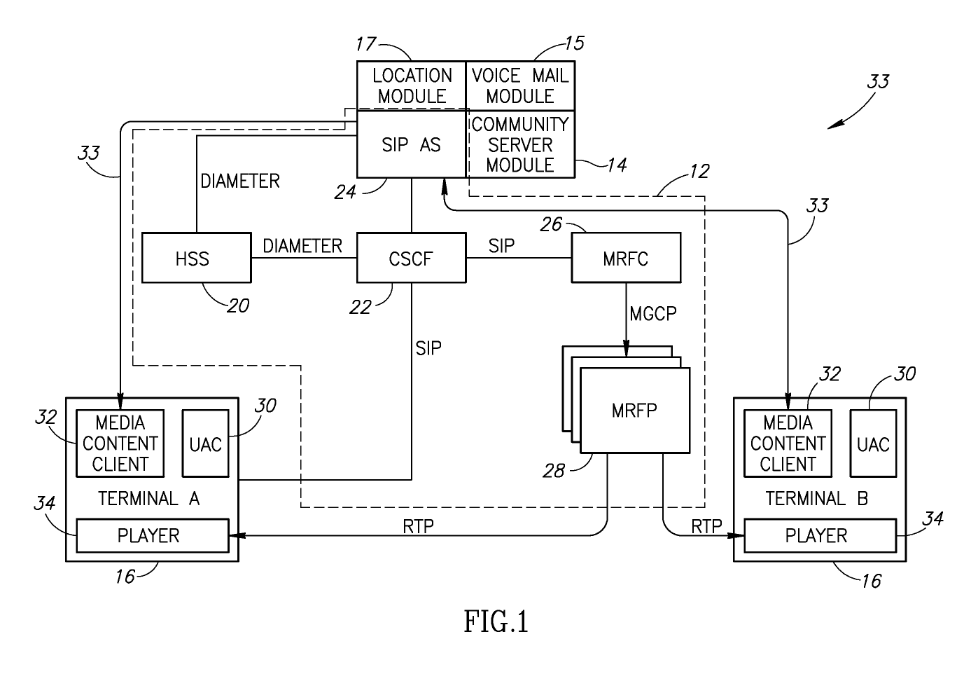

Reference is now made to FIG. 1, which illustrates one exemplary system 10 operative to provide multiple types of media content opportunities. FIG. 1 shows one implementation using IMS. The system of the present invention may be implemented with any other system capable of providing media content to a terminal.

System 10 may comprise an IMS system 12 and a community server 14 and may be in contact with one or more terminals 16 (such as mobile handsets and/or landline digital telephones). IMS system 12 may be any IMS system and may comprise a home subscriber server (HSS) 20, a call session control function (CSCF) unit 22, a SIP (session initial protocol) application server 24, a media resource function controller (MRFC) 26 and a plurality of media resource function processors (MRFP) 28. Home subscriber server 20 may store customer profiles, listing the subscribers and the services to which they have subscribed. CSCF unit 22 may control the call operation and media resource units 26 and 28 may provide media related functions, such as the playing of videos, tones, announcements, etc, where MRFC 26 may indicate to MRFPs 28 to play various media content stored therein and each MRFP 28 may control different types of media. For example, there may be one MRFP 28 for each of video, audio, transcoding, etc Moreover, each MRFP 28 may be able to handle multiple sessions at a time. In accordance with a preferred embodiment of the present invention, MRFPs 28 may store media content controlled by community server 14 which may be selected by the users of community server 14 for their buddies or for other purposes.

SIP Application server 24 may be a type of unit which may run a variety of different application modules. For example, application server 24 may run a voicemail module 15, a location identifying module 17, etc. Application server 24 may also run community server 14, as a separate module.

As in all IMS systems, terminals 16 have user agent clients (UACs) 30 on them. In accordance with a preferred embodiment of the present invention, terminals 16 may also include a media content client 32 responsible for controlling a media player 34, a standard element of most terminals 16, to display media content downloaded or streamed to it from media resource function processor 28. Player 34 may be a video player or an audio player or any other type of multimedia player.

Each media content client 32 may open a session (shown with arrow 33) with SIP application server 24 upon start-up of its terminal 16 or at any other suitable time. Each session may become active whenever community server 14 may want to display media content on the associated terminal 16, such as in response to the triggering events discussed hereinabove. Each media content client 32 may also function as a user agent client for IMS, in order to communicate with media resource function processor 28.

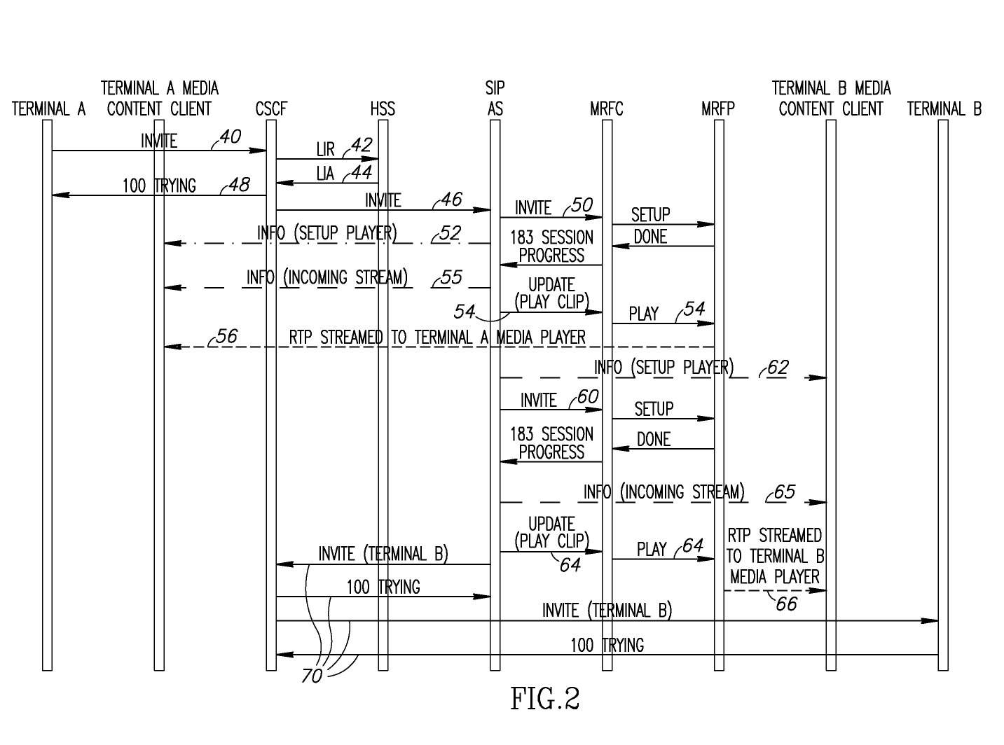

FIG. 2, to which reference is now also made, illustrates the call flow for call-related triggering events, such as when calling or when receiving a call. Terminal A may dial the phone number of Terminal B (this call flow assumes that terminals A and B are part of the same IMS-based network). In response to the dial operation, user agent client 30 may send (arrow 40) an INVITE to call session control unit 22. Unit 22 may then authenticate terminal A and may notify (step 42) home subscriber server 20 that terminal A is currently registered. Home subscriber server 20 may then provide (step 44) call session control unit 22 with the customer profile for terminal A.

Call session control unit 22 may determine that the customer profile for terminal A includes the service provided by community server 14 and, as a result, may forward (step 46) an INVITE to application server 24 for community server 14. At the same time, call session control unit 22 may reply (step 48) to user agent client 30 of terminal A with a 100 “trying” signal.

As discussed hereinabove, application server 24 may run community server 14. Thus, the invitation may be provided to community server 14 which may note that terminal A is calling terminal B. As discussed in U.S. Ser. No. 11/544,938, community server 14 may check whether or not customer B of terminal B is a registered buddy of customer A of terminal A and then may determine which media content should be played on each terminal, based on the selections of the two customers. If the two customers are buddies, then community server 14 may have media content chosen for customer A by customer B and generally other media content chosen for customer B by customer A. What will be displayed to customer A when calling customer B is called a “ringback” and what will be displayed to customer B when receiving a call from customer A is called a “ring forward”. If the two customers are not buddies, then customer A may have defined default media content to play when ringing non-buddies. Customer B may also have defined default media content to play when called by non-buddies.

For all the cases, community server 14 may look up which media content is to be displayed on terminals A and B and may indicate to application server 24 to provide the media content to the two terminals. Application server 24 may then do the following:

1. INVITE (step 50) a media resource function controller 26 to stream the appropriate media content for terminal A over RTP to media content client 32 on terminal A;

2. Send (step 52) an UPDATE or INFO message to media content client 32 on terminal A, via open session 33. This messages may include instructions to prepare player 34 for playing media content that shall be streamed from a media resource function processor 28;

3. Tell (step 54) media resource function processor 28 (via controller 26) to start streaming the media content; and

4. Once media resource function processor 28 is ready to stream the content, send (step 55) an UPDATE or INFO message to media content client 32 on terminal A, via open session 33, that the content is coming.

The result is that the appropriate media content, chosen for customer A by customer B or the default content, may begin playing (step 56) on terminal A. A similar process (see steps 5-8 below) may occur towards terminal B, before or after call session control unit 22 may INVITE (steps 70) terminal B for a call.

Application server 24 may perform the following towards terminal B:

5. INVITE (step 60) media resource function controller 26 to stream the appropriate media content for terminal B over RTP to media content client 32 on terminal B;

6. Send (step 62) an UPDATE or INFO message to media content client 32 on terminal B, via its open session 33, telling it to prepare its player 34 for playing media content that shall be streamed from a media resource function processor 28;

7. Tell (step 64) media resource function processor 28 (via controller 26) to start streaming the media content for terminal B; and

8. Once media resource function processor 28 is ready to stream the content, send (step 65) an UPDATE or INFO message to media content client 32 on terminal B, via open session 33, that the content is coming.

The result is that the appropriate media content, chosen for customer B by customer A, may begin playing (step 66) on terminal B.

At some point, customer B of terminal B may answer the phone call. A 200 type signal may be sent from terminal B to call session control unit 22 which, in turn, may send a 200 signal to application server 24. Application server 24 may send an INFO or UPDATE message, via open sessions 33, to terminals A and B with a command to stop playing media. Application server 24 may also tell call session control unit 22 to send a 200 type signal to user agent client 30 of terminal A, to activate the call. Application server 24 may send BYE messages to media resource function controllers 26 to tear down both media sessions.

Customers A and B on terminals A and B may now converse.

It will be appreciated that the call flow of FIG. 2 is for terminals A and B of the same IMS-based telephone system. If they belong to different systems, then each system may have its own application server and both application servers may communicate with community server 14.

Similar processes may be implemented for the other types of triggering events. For example, if customer B is busy, then a 486 BUSY HERE reply to an INVITE signal may be sent to call session control unit 22. Unit 22 may then forward the reply to application server 24 which, in turn, may forward it to community server 14. Community server 14 may determine the appropriate media content to be displayed on terminal A when customer B is busy and the signaling discussed hereinabove (steps 50-56) may be implemented to change the media content on terminal A. A similar process may occur if customer A is to receive a ‘call waiting’ signal from customer B.

Since each media content client 32 may have open session 33 with community server 14, which session is external to IMS system 12, community server 14 may communicate with terminals 16 at any desired time. Thus, steps 50-56 may also be implemented for the operator-related triggering events. For example, voicemail module 15 may send a command to application server 24 which may provide it to community server 14 which, in turn, may determine the appropriate media content for a terminal having a predefined voicemail status, such as receipt of a new voicemail, the presence of voicemails in the mailbox, etc. Community server 14 may then invoke application server 24 to implement steps 50-56 with respect to the terminal.

Similarly, application server 24 may implement steps 50-56 when the customer joins the network, turns on the phone, etc. Location-based triggering events may be activated by location-based application 17 processing the customer's current location (i.e. when passing locations of interest, utilizing a toll-road or in a particular area) and invoking community server 14 for the media content and application server 24 to initiate the streaming of the selected media content. A time-based application, processing time-based definitions, such as when the customer is known to be driving to work or when it's time for an afternoon snack, may also invoke community server 14 for the media content and application server 24 to initiate the streaming of the selected media content.

It will be appreciated that the content may be streamed at any time, whether or not as part of a phone call. Typically, application server 24 may check with call session control unit 22 to determine if the terminal of interest is in the middle of a call. Application server 24 may continue or not, depending on the rules for the particular application which invoked it. It will be appreciated that the present invention may stream the media content during the phone call since media content client 32 is a separate user agent client and is not involved in the operation of the phone call. Moreover, open session 33 may provide media content client 32 with a separate channel with which to communicate with application server 24.

It will further be appreciated that the present invention may utilize IMS system 12 to send media content, defined in community server 14, to terminals 16. This media content is typically not selected by the customers for themselves. Rather, it can be selected for them by their friends, or with respect to operator-related triggering events. It will be appreciated that customers can also choose the media content to be received for the operator-related triggering events as well.

It will be appreciated that the triggering events described hereinabove originated within the operator's network. SIP application server 24 was activated either by call session control unit 22 or by any of the other modules forming part of application server 24. In accordance with a second preferred embodiment of the present invention, media content client 32 may activate application server 24 via open session 33. This may be useful for triggering off actions of terminals 16, such as, for cellular telephone terminals, when the terminal may be unlocked, flipped open or slid open, where the particular action will depend on the type of terminal.

Media content client 32 may receive a signal from the terminal, such as through an API (application programming interface), about a terminal action of interest. Media content client 32 may then send an instruction (via open session 33) to application server 24 to activate steps 50-56 for the relevant terminal action of interest.

Unless specifically stated otherwise, as apparent from the previous discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
providing media content to a terminal for playing by a media player on said terminal in response to triggering events originating at a network operator.

2. The method according to claim 1 and wherein said providing comprises activating an IMS (IP Multimedia Subsystem) system to provide said media content.

3. The method according to claim 2 and wherein said activating comprises:
having an open session between a media content client on a terminal and an IMS application server;
using said open session to instruct said media content client to activate said media player; and
instructing an IMS media resource unit to provide said media content to said terminal.

4. The method according to claim 1 and wherein, for call-related triggering events, said activating comprises providing media content to at least one of the terminals involved in said call.

5. The method according to claim 4 and wherein a first media content provided to a first terminal is selected by a user of a second terminal.

6. The method according to claim 5 and wherein a second media provided to said second terminal is selected by a user of said first terminal.

7. The method according to claim 1 and wherein said triggering events are generated by at least one non-call-related application.

8. The method according to claim 7 and wherein said at least one non-call-related application is one of the following applications: a voicemail module, a location module and a timing module.

9. A system comprising:
means for receiving triggering events from a network operator; and
means for providing media content to a terminal for playing by a media player on said terminal in response to said triggering events.

10. The system according to claim 9 and wherein said means for receiving is an application server of an IMS system and wherein said means for providing comprises at least one media resource unit of said IMS system and a community server to associate media content with terminals of said IMS system and in response to triggering events and to activate said IMS system to provide media content to a relevant said terminal in response to a relevant said triggering event.

11. The system according to claim 9 and also comprising at least one non-call-related application to activate said community server in response to one said triggering event.

12. The system according to claim 11 and wherein said at least one non-call-related application is one of the following: a voicemail module, a location module and a timing module.

13. The system according to claim 9 wherein said triggering event is a call-related triggering event between a first and a second terminal and wherein said community server has associated at least a first media content selected by a user of a second terminal with said first terminal.

14. The system according to claim 13 and wherein said community server has associated a second media selected by a user of said first terminal with said second terminal.

15. A multimedia terminal comprising:
a media player;
a telephony client to provide telephony via a telephony operator; and
a media player controller to activate and deactivate said media player in response to externally provided instructions.

16. The terminal according to claim 15 and also comprising a session controller to open a session with an application server of an IMS system and to receive said instructions from said application server.

17. The terminal according to claim 16 and also comprising a triggering event determiner to instruct said application server when a triggering event on said terminal occurs.
